(19) United States
(12) Patent Application Publication
(10) Pub. No.: US 2006/0075509 A1
(43) Pub. Date: Apr. 6, 2006

(54) Data storage protection device

(76) Inventor: Jakob Kishon, Brea, CA (US)

Correspondence Address: RICHARD D. CLARKE;LAW OFFICE OF RICHARD D. CLARKE, 3755 AVOCADO BLVD., #1000, LA MESA, CA, 91941-7301, US

(21) Appl. No.: 11/270,002

(22) Filed: Nov. 9, 2005

Related U.S. Application Data
(63) Continuation-in-part of application No. 10/443,625, filed on May 22, 2003.

(51) Int. Cl. G06F 11/00

(52) U.S. Cl. 726/34

(57) ABSTRACT

The present invention involves a networked device that protects electronically stored data in case of impact, fire, flood, or other damaging condition. The invention includes a hard disk drive enclosed within a waterproof enclosure that is encapsulated within a fire resistant ceramic box. A vent assembly is used to cool the disk drive, and insulation including phase change materials is used to maintain the internal temperature of the drive during normal operation and fire conditions. In addition, a second drive which is user removable is provided (the removable hard disk drive) that is used to mirror the data stored in the sealed drive. The two drives are configured in RAID1 configuration providing redundancy and protection against data corruption. The invention utilizes electronic sensors to detect potential damaging conditions, and upon such detection, power to the device is disconnected and software automatically causes an alarm message to be displayed at a host computer. The invention contains software to provide a graphical user interface that allows authorized personnel to monitor the device and enable security features such as when the disk drive can be removed, who can remove it, and when it can be accessed.

This application is a Continuation-In-Part (CIP) of U.S. patent application Ser. No. 10/443,625, filed on May 22, 2003.

### BACKGROUND OF THE INVENTION

1. Field of the Invention

The present invention relates to the field of data storage protection devices. More specifically, the preferred embodiment of the present invention involves a network-attached waterproof, fireproof, and theft and impact resistant device that allows for safe storage and protection of electronic data, while providing multiple user access and protection of the electronically stored data.

2. Description of the Related Art

As society continues to generate increasingly more electronic data through the use of computers and other electronic devices for everyday affairs, the need for secure, reliable, convenient, and affordable protection of electronic data has increased exponentially. For quite some time there has been a need for a device that can fully protect data stored in an electronic format from potential damaging conditions such as fire, flooding, and impact. Prior attempts to provide a practical and device that satisfies the full range of current needs in data storage protection have fallen short of the mark in several aspects.

As an example, there exist commercially available “safes” that can be used to store removable data media such as floppy discs, tapes, magnetic tape optical CDs, and removable drives. However, these devices require that the user continuously make a copy of the data they wish to secure from the operating computer or other data collection device, and then secure it in the safe each time the user wishes to save the data. This cumbersome and time consuming process is likely to be ignored in many cases and uses. For example, where the data is manipulated on a computer, the user would be required to open the safe and retrieve the media each time the data is to be accessed in order to keep the most recent data secured.

Because previous devices for storing data have not enabled the simultaneous dynamic storage capability and protection of electronic data, it would be highly desirable to provide a single waterproof, fireproof, and theft and impact resistant device that allows for the safe storage and protection of electronic data captured from a host computer without having to utilize several storage mediums and continuously manually update stored data.

In this respect, before explaining at least one embodiment of the invention in detail it is to be understood that the invention is not limited in its application to the details of construction and to the arrangement of the components set forth in the following description or illustrated in the drawings. The invention is capable of other embodiments and of being practiced and carried out in various ways. In addition, it is to be understood that the phraseology and terminology employed herein are for the purpose of description and should not be regarded as limiting.

### SUMMARY OF THE INVENTION

The principle advantage of this invention is to provide a device that protects electronically stored data in the event of fire, flood, theft, or other potential damaging condition.

Another advantage of this invention is to provide an electronic data storage device that can protect against damage while being connected to a network.

Another advantage of this invention is to provide an electronic data storage device that can support a variety of standard electronic interfaces.

Another advantage of this invention is to provide a system that can sense imminent danger to a data storage device and cause the electronic data storage device to carry out predetermined instructions with respect to stored data.

And still another advantage of this invention is to provide an electronic data storage device that can maintain its internal temperature during both normal operation and fire conditions.

A further advantage is to create an electronic storage device that, upon detection of potentially dangerous conditions, can transmit information to a host computer and cause notification messages to be displayed on the host computer.

And yet a further advantage is to create an electronic storage device that contains software for displaying a graphical user interface on a host computer for the purpose of allowing an administrator to monitor and control the electronic storage device.

And still a further advantage of this invention is to add a new and unique device to the field of electronic data storage.

These advantages, and other advantages of the invention, will be apparent to those of ordinary skill in the art from the disclosure of the present invention as set forth herein.

The present invention involves a networked device that protects electronically stored data in case of impact, fire, flood, or other damaging condition. The invention includes a hard disk drive enclosed within a waterproof enclosure that is encapsulated within a fire resistant ceramic box (the sealed hard disk drive). In addition, a second drive which is user removable is provided (the removable hard disk drive) that is used to mirror the data stored in the sealed drive. The two drives are configured in RAID 1 configuration providing redundancy and protection against data corruption. The removable drive is not fire or water proofed. A vent assembly is used to cool the sealed disk drive and insulation including phase change materials is used to maintain the internal temperature of the drive during normal operation and fire conditions. The invention utilizes electronic sensors to detect potential damaging conditions, and upon such detection, power to the device is disconnected and software automatically causes an alarm message to be displayed at a host computer. The invention contains software to provide a graphical user interface that allows authorized personnel to monitor the device and enable security features such as when the removable disk drive can be removed, who can remove it, and when it can be accessed.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

The accompanying drawings, which are incorporated in and form a part of this specification, illustrate embodiments of the invention and together with the description, serve to explain the principals of this invention.

FIG. 1 depicts a perspective view of a vertical cross-section of the data storage protection device with the ceramic cover open, constructed in accordance with the present invention;

FIG. 2 depicts a perspective view of the sealed hard disk drive box, constructed in accordance with the present invention;

FIG. 3A depicts a side view the sealed hard disk drive box, constructed in accordance with the present invention;

FIG. 3B depicts a partially cut away top perspective view of the sealed hard disk drive box, constructed in accordance with the present invention;

FIG. 4 depicts a detailed perspective view of a cross-section of transition printed circuit board assembly mounted in the sealed hard disk drive box, constructed in accordance with the present invention;

FIG. 5 depicts a partially cut away perspective view of the cooling process of the sealed hard disk drive box, showing the sealed hard disk drive connected to the vent assembly, constructed in accordance with the present invention;

FIG. 6 depicts a partially cut away perspective view of the Styrofoam box illustrating the flexible printed circuit in proximity to the flex connector, constructed in accordance with the present invention;

FIG. 7 depicts a cross-section view of the data storage protection device, illustrating the air flow through the data storage protection device, constructed in accordance with the present invention;

FIG. 8 depicts a perspective view of a vertical cross-section of the data storage protection device under fire conditions with the ceramic cover closed, constructed in accordance with the present invention;

FIG. 9 depicts a perspective view of the ceramic cover in the open position and attached to the spring assembly, constructed in accordance with the present invention;

FIG. 10 depicts a detailed view of the ceramic cover in the open position and attached to the spring assembly, illustrating the preferred embodiment for keeping the ceramic cover in the open position using a fusible alloy clip, constructed in accordance with the present invention;

FIG. 11A depicts a side view of the thermal fuse, constructed in accordance with the present invention;

FIG. 11B depicts a front view of the thermal fuse, constructed in accordance with the present invention;

FIG. 12 depicts there is shown a side view of the ceramic cover in the open position and attached to the spring assembly, illustrating an alternative embodiment for keeping the ceramic cover in the open position using a thermal fuse, constructed in accordance with the present invention;

FIG. 13A depicts a perspective view of the data storage protection device with the ceramic cover in the open position, illustrating the connection of the flexible printed circuit to the main controller electronic board and the sealed hard disk drive, constructed in accordance with the present invention;

FIG. 13B depicts a detailed perspective view of the connection of the flexible printed circuit to the cavity in the top cover of the sealed hard disk drive box, constructed in accordance with the present invention;

FIG. 14A depicts a detailed view of an alternative method for preventing the flexible printed circuit from becoming a potentially destructive thermal conduction path to the sealed hard disk drive, illustrating the combined flexible printed circuit partially within the ceramic box (represented by dotted lines), constructed in accordance with the present invention;

FIG. 14B depicts a detailed view of an alternative method for preventing the flexible printed circuit from becoming a potentially destructive thermal conduction path to the sealed hard disk drive, illustrating the separation of the flexible printed circuit into segments, constructed in accordance with the present invention;

FIG. 15A depicts a partial front view of the preferred embodiment of the data storage protection device, illustrating the exterior casing with removable hard drive access door closed, constructed in accordance with the present invention;

FIG. 15B depicts a partial front view of the preferred embodiment of the data storage protection device, illustrating the exterior casing with the removable hard drive access door open and showing the removable hard disk drive in place, constructed in accordance with the present invention;

FIG. 16 depicts an exploded view of the thermal fuse, constructed in accordance with the present invention;

FIG. 17 depicts a perspective view of the thermal fuse outside of the data storage protection device, constructed in accordance with the present invention;

FIG. 18 depicts a detailed view the thermal fuse in place attached to the hinge assembly and ceramic cover on the data storage protection device, constructed in accordance with the present invention;

FIG. 19 depicts fire and water detected alarm messages that appear on the controlling CPU when either fire or water is detected; constructed in accordance with the present invention;

FIG. 20 depicts both an authorization notification message that appears when security features have been activated and a user attempts to delete a file or folder, and an access denied warning message that appears when a user tries to access files or folders outside the designated time period, constructed in accordance with the present invention;

FIG. 21 depicts both a drive door open warning message that appears when the removable hard disk drive access door is open, and a drive door breached warning message that appears when the removable hard disk drive access door is forced open without an authorized eject command from the user interface, constructed in accordance with the present invention;

FIG. 22 depicts the concept of the authorization button that is physically located on the front of the data storage protection device, constructed in accordance with the present invention; and

FIG. 23 depicts the user interface of the controlling CPU, constructed in accordance with the present invention.

### DETAILED DESCRIPTION OF THE PREFERRED EMBODIMENTS

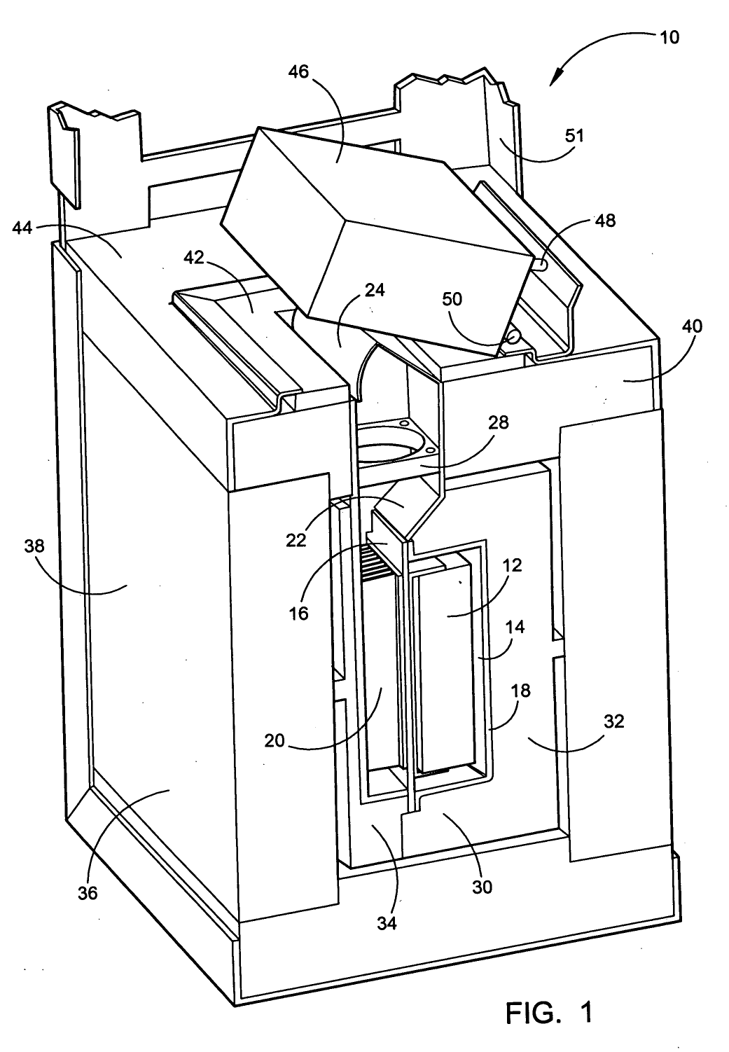

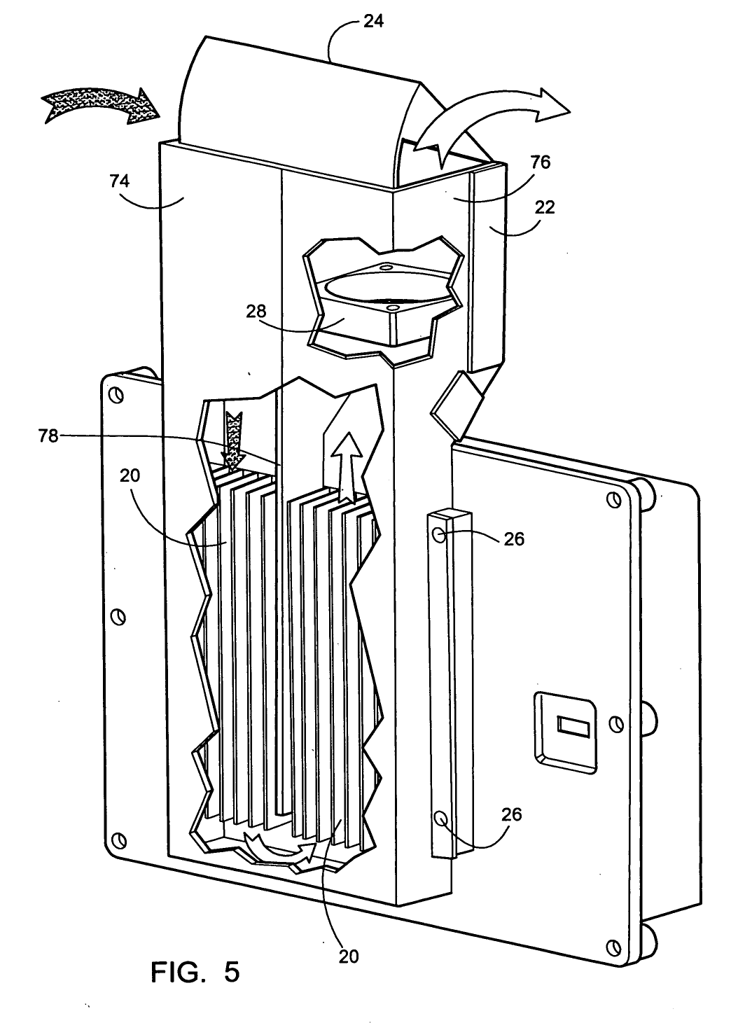

Referring now to the drawings, wherein similar parts are identified by like reference numerals, there is seen in FIG. 1 a perspective view of a vertical cross-section of data storage protection device 10 standing alone in preferably a secured environment, Note that the removable hard disk drive is not shown in this FIG for clarity. Data storage protection device 10 contains a sealed hard disk drive 12 that is enclosed within a sealed hard disk drive box 14. Sealed hard disk drive box 14 includes a top cover 16 and a bottom portion 18. Bottom portion 18 is preferably constructed of molded plastic, but can be comprised of other materials as recognized by one with ordinary skill in the art. Heat sinks 20 are fixed to top cover 16 to assist in cooling sealed hard disk drive 12. A vent assembly 22 with a dual chamber design (see FIG. 5) and a deflector cover 24 is attached to heat sinks 20 by screws 26 (see FIG. 5) to assist in cooling sealed hard disk drive 12. It is to be understood that vent assembly 22 can be attached to heat sinks 20 by other traditional fasteners attachment means as recognized by one with ordinary skill in the art. A vent fan 28 is situated within vent 22 to create suction and draw cool air into vent assembly 22 and over heat sinks 20 when deflector cover 24 is in the open position.

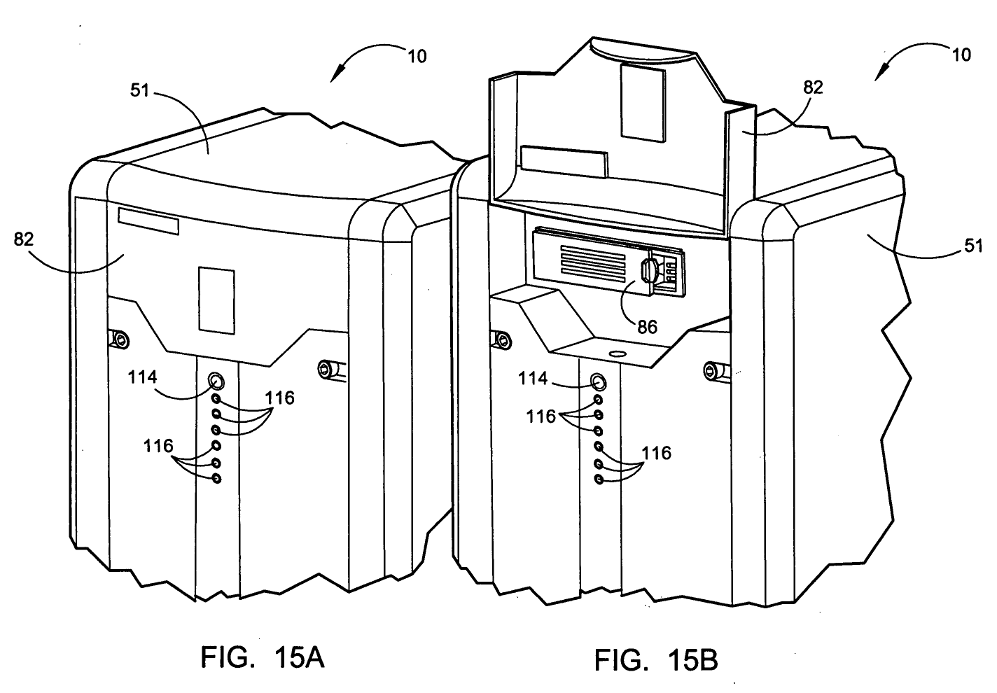

Sealed hard disk drive box 14, heat sinks 20, and vent assembly 22 are substantially contained within Styrofoam box 30. Styrofoam box 30 comprises a back portion 32 and a front portion 34. Back portion 32 and front portion 34 are clamped together to form a tight seal that encloses the combination of sealed hard disk drive box 14 with sealed hard disk drive 12, heat sinks 20, and vent assembly 22, with the exception of an opening for receiving vent assembly 22. Styrofoam box 30 is enclosed by ceramic box 36. Ceramic box 36 contains a bottom portion 38 and a top cover 40. Top cover 40 is comprised of a low thermal conductivity ceramic material, with a high temperature gasket 42 and sheet metal 44 providing structure. High temperature gasket 42 and sheet metal 44 contain an opening to receive vent assembly 22 and allow air flow to heat sinks 20. A ceramic cover 46 is positioned over deflector cover 24 and the opening in vent assembly 22 in either the open or closed position. In the preferred embodiment of the present invention ceramic cover 46 is spring loaded. However, other conventional means and methods can be used to close ceramic cover 46 as recognized by one with ordinary skill in the art. When in the open position, ceramic cover 46 is held open by a fusible alloy clip 48. Fusible alloy clip 48 is connected to a hinge mechanism 50 that is attached to top cover 40. An exterior casing 51 encloses ceramic box 36 (see FIG. 15A and FIG. 15B), serving as additional protection from fire, flood, or impact.

As is well understood, it is necessary to protect data storage devices from excessive heat because data storage devices are susceptible to damage if they are exposed to high heat. High heat can result from excess heat generated by the normal operation of data storage protection device (internal excess heat) or from an external source such as a fire (external excess heat). Data storage devices typically have a maximum recommended operating temperature above which injury to the data storage unit, or the data stored thereon, can be expected to occur. The present invention is intended to protect sealed hard disk drive 12 from reaching this maximum temperature threshold both from internal excess heat and external excess heat.

In order to insure uninterrupted functioning of typical data storage devices, it is necessary that the internal temperature of the internal data storage device during normal operation, sealed hard disk drive 12 in the preferred embodiment of the present invention, is maintained at a temperature of 65 degrees Celsius or cooler. Likewise, in the case of an external excess heat event, the requirements of the thermal test portion of UL 72, Tests for Fire Resistance of Record Protection Equipment, Class 125, provide that the data storage device temperature should not exceed 125 degrees Celsius for one hour during a fire and/or throughout the test.

Sealed hard disk drive 12 is attached to the inside of top cover 16 in one of many ways known to those with ordinary skill in the art which allows heat generated during normal operation of the data storage device to be conducted into the walls of sealed hard disk drive box 14 and away from sealed hard disk drive 12. In the preferred embodiment, this is achieved by attaching sealed hard disk drive 12 to a sheet metal bracket with screws (see FIG. 3A and FIG. 3B). Top cover 16 is in direct contact with heat sinks 20, which allows internal excess heat to dissipate into and pass through vent assembly 22.

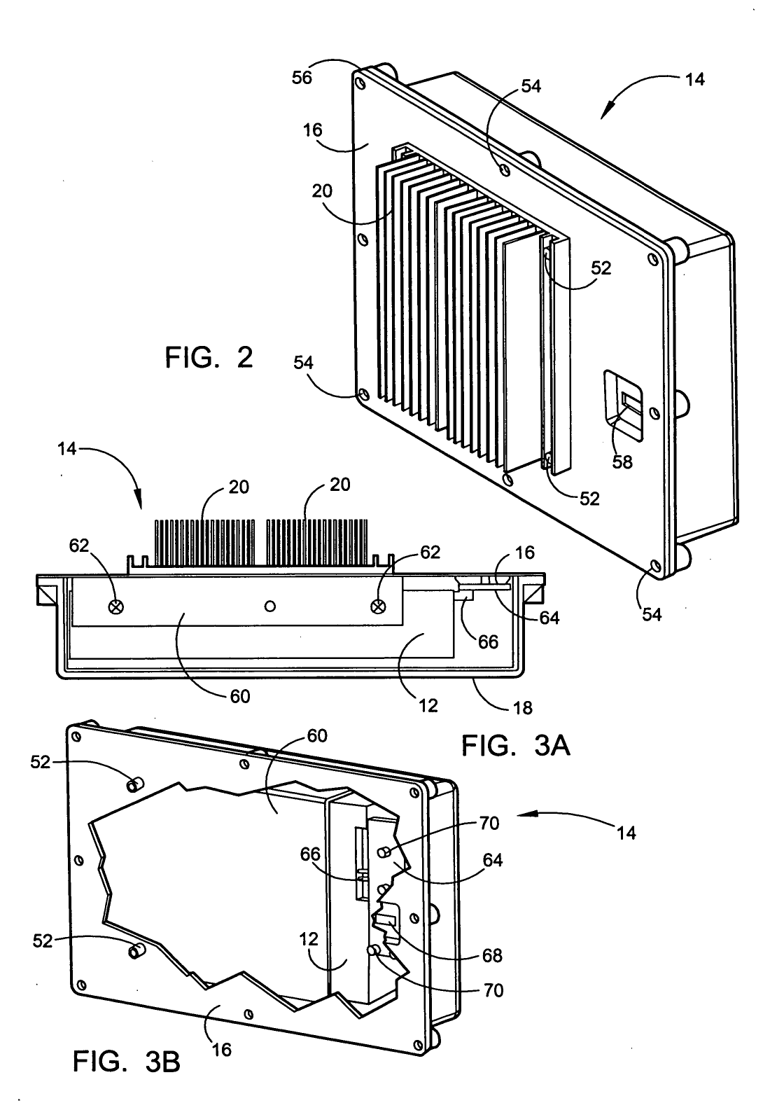

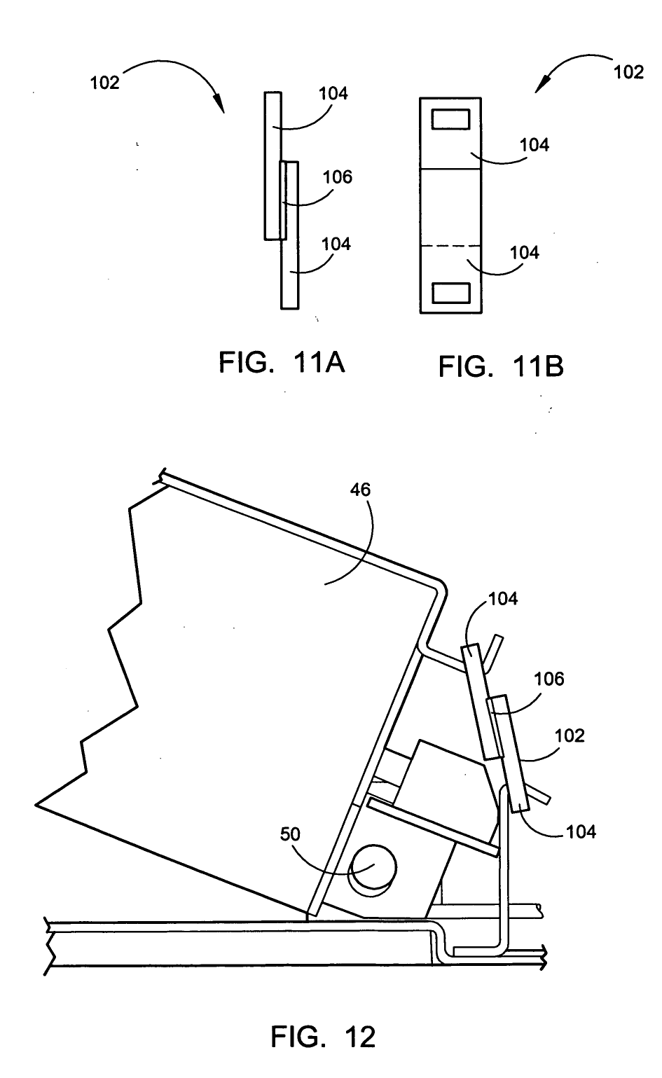

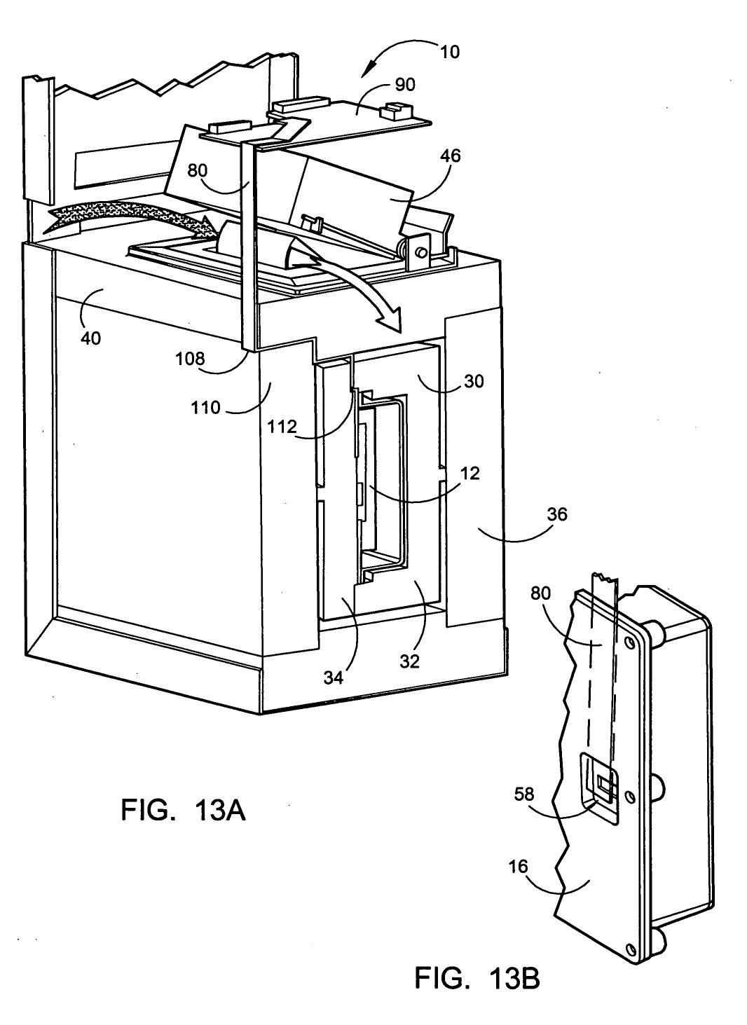

As illustrated in FIG. 2, there is seen a perspective view of sealed hard disk drive box 14 with heat sinks 20 attached to top cover 16. Top cover 16 can be made of metal or any other suitable conductive material as recognized by one with ordinary skill in the art. The external surface of top cover 16 contains four mounting standoffs 52 (only two shown) that are used to mount heat sinks 20. Top cover 16 is attached to bottom portion 18 via eight screws 54. It is to be recognized that top cover 16 can be attached to bottom portion 18 via other traditional attachment methods or means as recognized by one with ordinary skill in the art, including but not limited to fastening, clipping, gluing, or clamping. A water sealed gasket 56 is pressed between top cover 16 and bottom portion 18 to create a water tight seal for sealed hard disk drive box 14. Top cover 16 contains a cavity 58 with an opening to receive a flexible printed circuit (see FIG. 13B).

As illustrated in FIG. 3A, there is seen a side view of the sealed hard disk drive box 14, containing sealed hard disk drive 12, heat sinks 20, top cover 16, bottom portion 18, sheet metal bracket 60, screws 62, transition printed circuit board assembly 64, and native hard disk drive SATA connector 66.

As illustrated in FIG. 3B, there is seen a partially cut away top perspective view the sealed hard disk drive box 14. Sealed hard disk drive 12 is mounted to a sheet metal bracket 60 via screws 62 (see FIG. 3A). Sheet metal bracket 60 is spot welded to top cover 16. A transition printed circuit board assembly 64 is used to connect a native hard disk drive SATA connector 66 to the external flex connector 68. Transitional printed circuit board assembly 64 is mounted internally within sealed hard disk drive box 14 to top cover 16 via four standoffs 70.

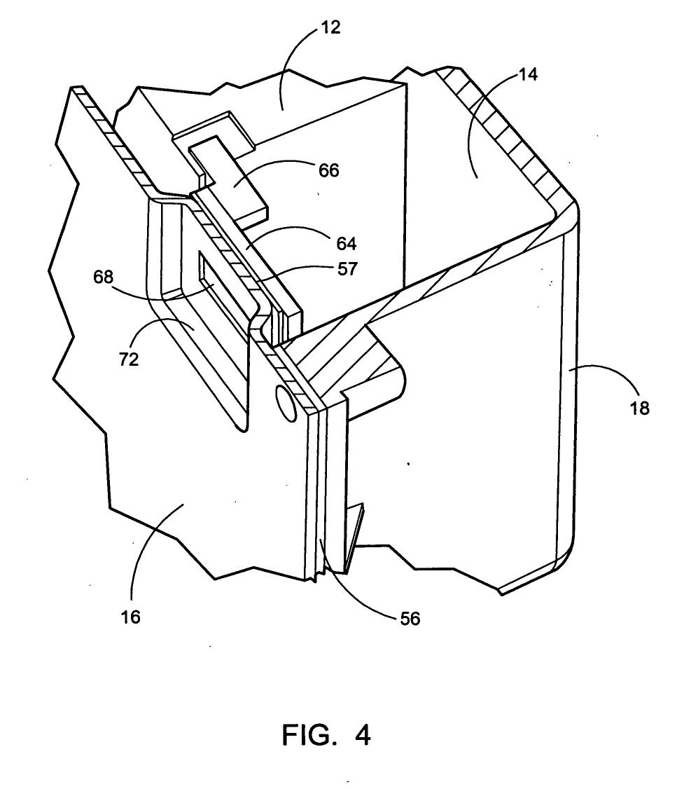

As illustrated in FIG. 4, there is seen a detailed perspective view of a cross-section of transition printed circuit board assembly 64 mounted in the sealed hard disk drive box 14, including sealed hard disk drive 12, top cover 16, bottom portion 18, water sealed gasket 56, and native hard disk drive SATA connector 66. External flex connector 68 is soldered to the opposite side of transition printed circuit board assembly 64 that extrudes through an opening 72 in top cover 16. External flex connector 68 provides power and data signaling to sealed hard disk drive 12 and provides connection/disconnection capability without the need to open sealed hard disk drive box 14. Water sealed gasket 57 is pressed between transition printed circuit board assembly 64 and top cover 16 to provide a tight waterproof seal between the two parts.

As illustrated in FIG. 5, there is seen a partially cut away perspective view of the cooling process of sealed hard disk drive box 12. Vent assembly 22 contains an intake chamber 74 and an exhaust chamber 76 separated by a wall 78. Vent fan 28 is mounted in exhaust chamber 76 to force cool air, represented by shaded arrows, to enter intake chamber 74, flow over and cool heat sinks 20, turning into heated air as represented by non-shaded arrows, and exit vent assembly 22 via exhaust chamber 76. The positioning of deflector cover 24 determines whether or not cool or heated air can pass through intake chamber 74 and exhaust chamber 76. Under fire conditions deflector cover 24 will be pushed down by ceramic cover 46 (see FIG. 1), closing vent assembly 22.

As illustrated in FIG. 6, there is seen a partially cut away perspective view of Styrofoam box 30, illustrating flexible printed circuit 80 in proximity to flex connector 70. Back portion 32 and a front portion 34 are clamped together to tightly enclose sealed hard disk drive box 14 and a portion of vent assembly 22. Styrofoam box 30 provides additional thermal insulation, mounting of sealed hard disk drive box 14 without the need for screws or other fasteners, and protects sealed hard disk drive box 14 against shock and vibration.

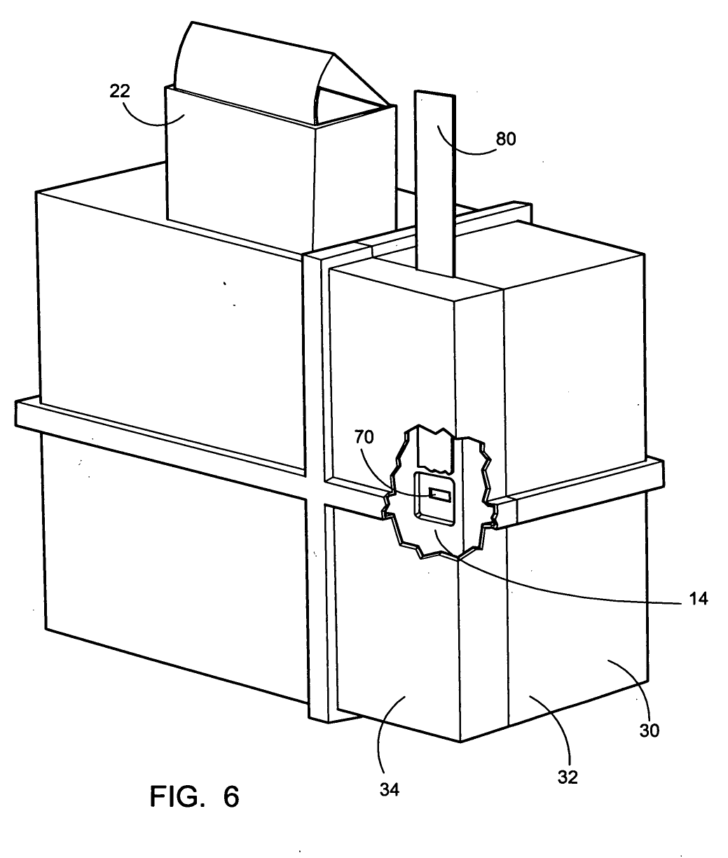

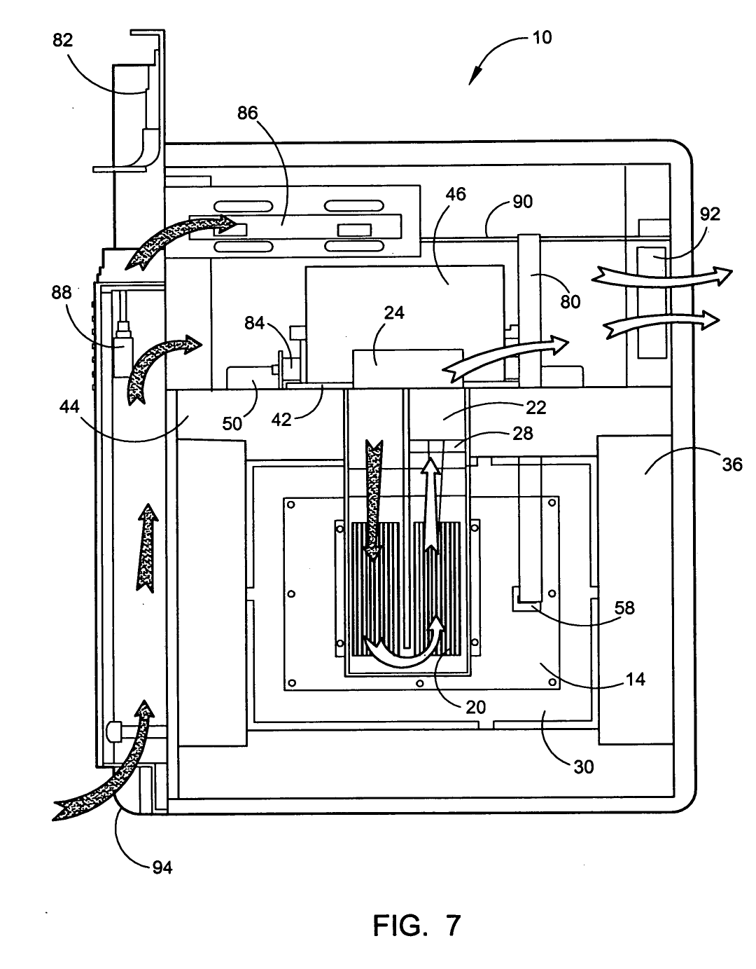

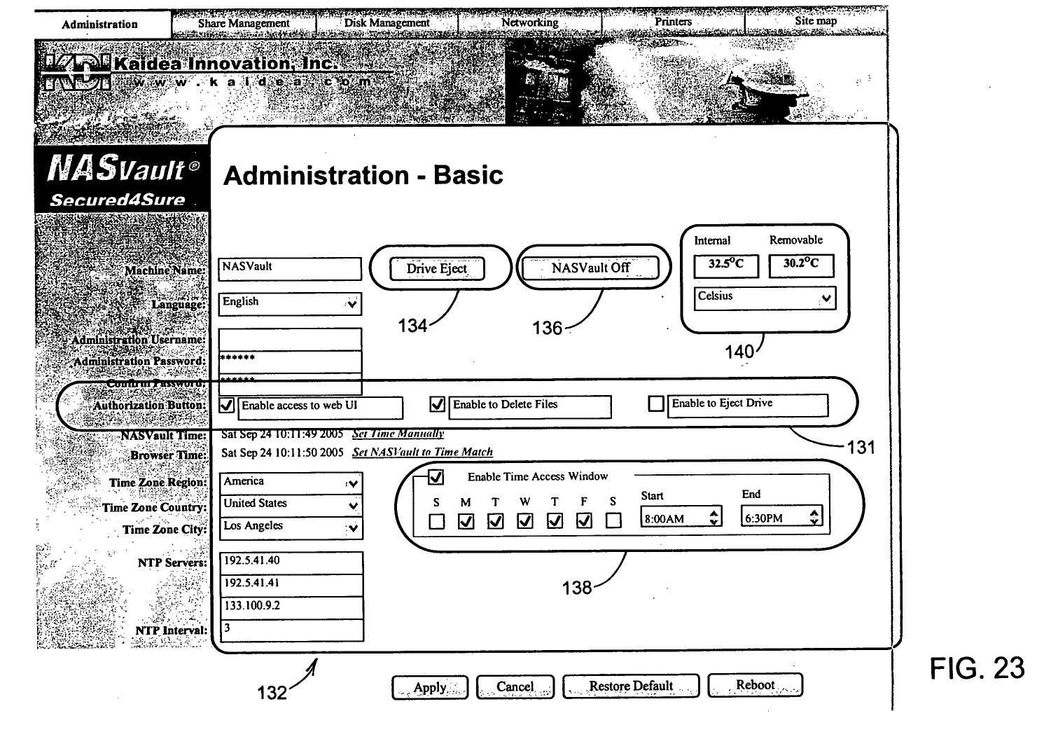

As illustrated in FIG. 7, there is a cross-section view of the data storage protection device 10, illustrating the air flow through data storage protection device 10, including sealed hard disk drive box 14, heat sinks 20, vent assembly 22, deflector cover 24, vent fan 28, Styrofoam box 30, ceramic box 36, high temperature gasket 42, sheet metal 44, ceramic cover 46, cavity 58, and flexible printed circuit 80. Ceramic cover 46 is loaded by spring 84 connected to hinge mechanism 50. A removable hard disk drive 86 is positioned above ceramic cover 46 and serves as a mirror to sealed hard disk drive 12. Removable hard disk drive 86 can be removed by a user by activating a “drive eject” button on the user interface (see FIG. 23). When the “drive eject” button is activated, solenoid 88 will be energized resulting in removable hard drive access door 82 popping open. There is also a main controller electronic board 90 that is used to connect to removable hard disk drive 86 and to sealed hard disk drive box 14 via flexible printed circuit 80.

A fan 92 is provided to create air flow through data storage protection device 10. The suction created by fan 92 draws cool air, represented by shaded arrows, into an air intake 94 and through data storage protection device 10 to cool removable hard disk drive 86 and assist in removing residual heat from ceramic box 36. Air flowing into air intake 94 also flows through deflector cover 24, vent assembly 22, and over heat sinks 20, turning into heated air as represented by non-shaded arrows, then exits vent assembly 22 and is drawn by fan 92 to the back of data storage protection device 10.

As illustrated in FIG. 8, there is shown a perspective view of a vertical cross-section of data storage protection device 10 under fire conditions. When temperature reaches 58 degrees Celsius, fusible alloy clip 48 melts and causes ceramic cover 46 to close by releasing it from the tension of spring 84 (not shown). Deflector cover 24 retracts into vent assembly 22 and micro switch 96 (see FIG. 10) is deactivated resulting in power shut down of the data storage protection device 10.

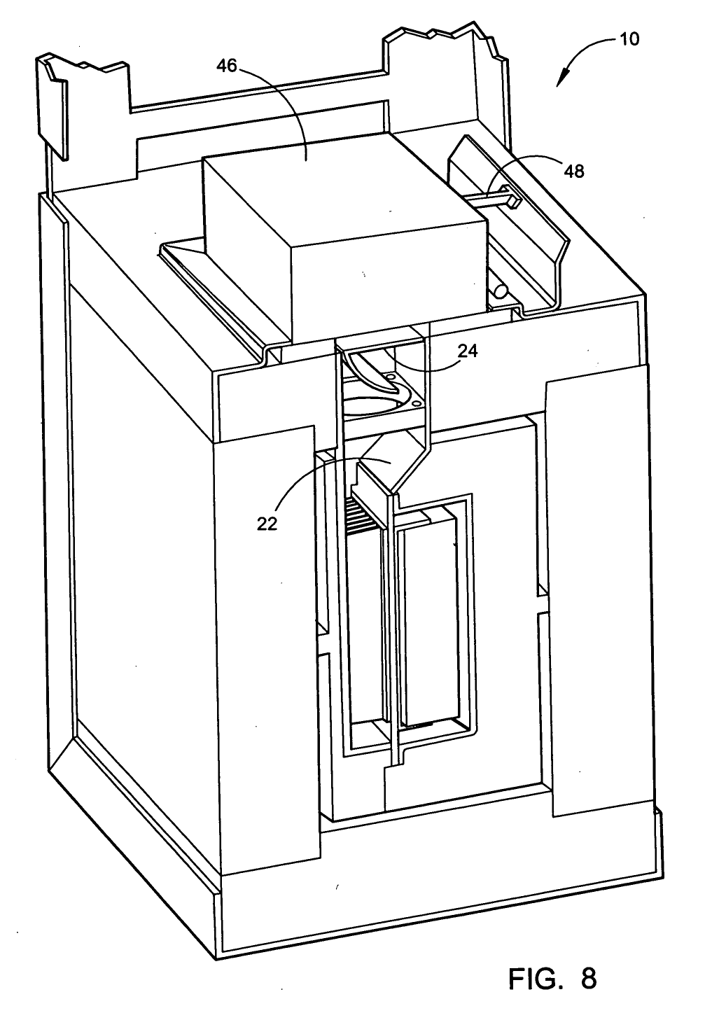

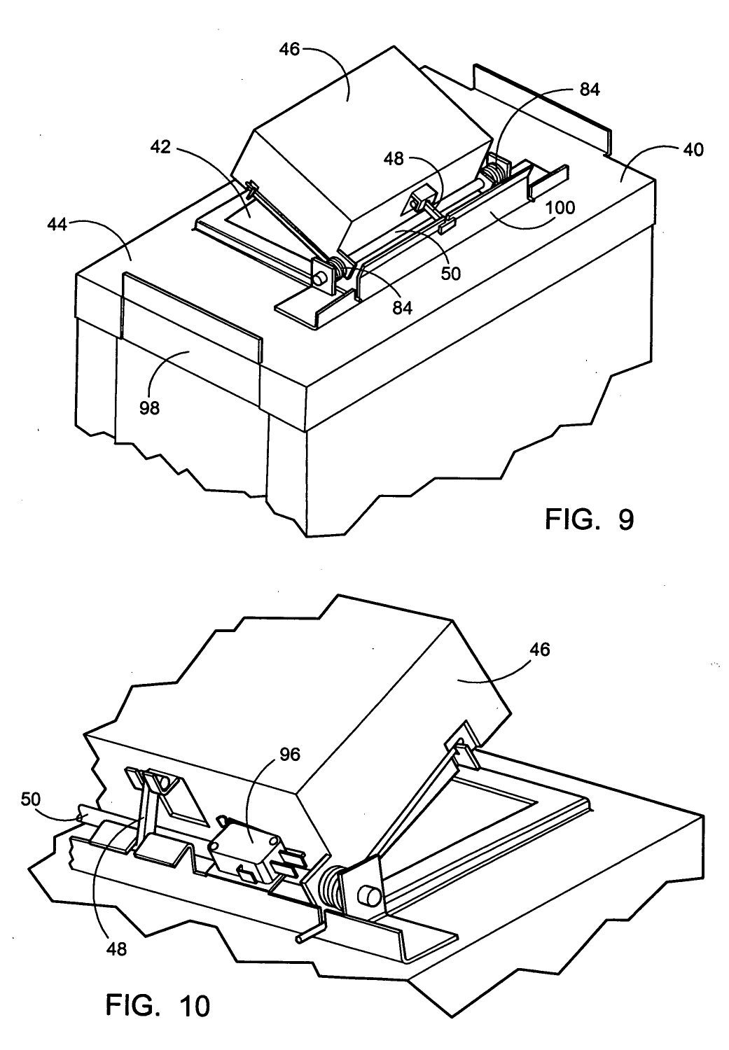

As illustrated in FIG. 9, there is shown a perspective view of ceramic cover 46 in the open position and attached to spring assembly 50. Spring assembly 50 is attached to top cover 40. Top cover 40 is comprised of a low thermal conductivity ceramic material 98, with high temperature gasket 42 and sheet metal 44 providing structure. Spring assembly 50 is assembled on sheet metal 44 and provides a hinge mechanism 100 for ceramic cover 46. Ceramic cover 46 is loaded by springs 84 and held open by fusible alloy clip 48, preventing ceramic cover 46 from closing. In addition, micro switch 96 (see FIG. 10) is activated when ceramic cover 46 is open. Under fire conditions fusible alloy clip 48 melts when it reaches 58 degrees Celsius and causes ceramic cover 46 to close by releasing it from the tension of springs 84, causing micro switch 96 to deactivate. When micro switch 96 deactivates, it will shut down power to sealed hard disk drive 12 (not shown) and send a notification message to the controlling computer (not shown).

As illustrated in FIG. 10, there is depicted a detailed view of ceramic cover 46 in the open position and attached to spring assembly 50, illustrating the preferred embodiment for keeping ceramic cover 46 in the open position using fusible alloy clip 48. As shown, micro switch 96 is activated.

As illustrated in FIG. 11A, there is shown a side view of a thermal fuse 102, including metal parts 104 and solder material 106. Thermal fuse 102 holds the spring loaded ceramic cover 46 open under normal operating conditions (see FIG. 12). Thermal fuse 102 is preferably constructed from two metal parts 104 that are soldered together by a solder material 106. In the preferred embodiment, solder material 106 is lead-free and has a melting point of 70 degrees Celsius. However, in an alternative embodiment solder material 106 can also contain a low quantity of lead, in accordance with industry regulations and standards, as one with ordinary skill in the art would recognize.

As illustrated in FIG. 11B, there is shown a front view of thermal fuse 102, including metal parts 104.

As illustrated in FIG. 12, there is shown a side view of ceramic cover 46 in the open position and attached to spring assembly 50, illustrating an alternative embodiment for keeping ceramic cover 46 in the open position using a thermal fuse 102. When the ambient temperature exceeds 70 degrees Celsius, solder material 106 will melt and metal parts 104 will break away, releasing ceramic cover 46 and causing the closure of ceramic box 36 (not shown).

As illustrated in FIG. 13A, there is shown a perspective view of data storage protection device 10 with ceramic cover 46 in the open position, illustrating the connection of flexible printed circuit 80 to main controller electronic board 90 and transition printed circuit board assembly 64 (not shown). During a fire, flexible printed circuit 80 can provide an unwanted and potentially destructive thermal conduction path to sealed hard disk drive 12. To prevent this possibility, the preferred embodiment of limiting unwanted excess heat is to bend flexible printed circuit 80 in a torturous path through the ceramic box interface area 108 between top cover 40 and the ceramic side wall 110 of ceramic box 36, and through Styrofoam box 30 at the Styrofoam box interface area 112 between back portion 32 and a front portion 34. It is to be recognized that the path of the flexible printed circuit 80 can be any serpentine winding through the various layers of data storage protection device 10 that will enable flexible printed circuit 80 to release as much heat as possible to the elements it encounters before reaching sealed hard disk drive 12.

Another embodiment that can be utilized to prevent flexible printed circuit 80 from serving as a destructive thermal conduction path to sealed hard disk drive 12 is to use a cable cutting and retraction system (not shown) either in addition to or in place of the serpentine path of the preferred embodiment. The cable cutting and retraction system can include a retractable blade or other cutting device arranged to sever flexible printed circuit 80 upon receipt of a signal that a fire or other potentially dangerous condition exists. The cable cutting and retraction system will also be provided with a spring-loaded receptacle which, upon flexible printed circuit 80 being severed, will retract it into the core of Styrofoam box 30. In an alternative embodiment, flexible printed circuit 80 may only be retracted a sufficient distance to remove the severed end of flexible printed circuit 80 away from the fire or other disaster source.

As illustrated in FIG. 13B, there is shown a detailed perspective view of the connection of flexible printed circuit 80 to cavity 58 in top cover 16.

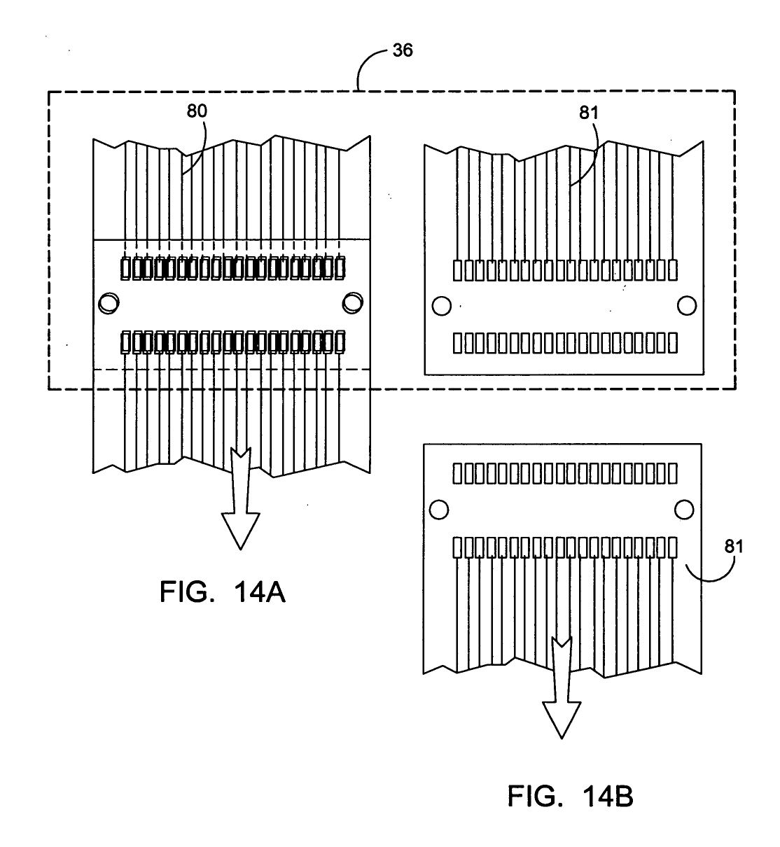

As illustrated in FIG. 14A, there is shown a detailed view of an alternative method for preventing flexible printed circuit 80 from becoming a potentially destructive thermal conduction path to sealed hard disk drive 12, illustrating flexible printed circuit 80 partially within ceramic box 36 (represented by dotted lines).

As illustrated in FIG. 14B, there is shown a detailed view of an alternative method for preventing flexible printed circuit 80 from becoming a potentially destructive thermal conduction path to sealed hard disk drive 12, illustrating flexible printed circuit 80 separated into flexible printed circuit segments 81. Flexible printed segments 81 are soldered together with low temperature solder that melts at 70 degrees Celsius, to form flexible printed circuit 80. The interface between flexible printed circuit segments 81 occurs within ceramic box 36. The portions of flexible printed circuit segments 81 that are located external to ceramic box 36 are loaded with a small amount of tension. Once the temperature exceeds 70 degrees Celsius, the low temperature solder melts and flexible printed circuit 80 will separate into flexible printed circuit segments 81, thus removing any potential destructive thermal conduction path to sealed hard disk drive 12.

As illustrated in FIG. 15A, there is shown a partial front view of the preferred embodiment of the data storage protection device 10, illustrating exterior casing 51 with removable hard drive access door 82 closed. Also depicted in the figure are the authorization button 114 and light emitting diodes (LEDs) 116. Authorization button 114 provides additional security for sensitive operations such as enabling access to the setup webpage, enabling a user to delete files, and enabling a user to open removable hard drive access door 82 to eject removable hard disk drive 86. LEDs 116 are used to notify a user of the operating condition of data storage protection device 10, such as whether it is on or in standby mode.

As illustrated in FIG. 15B, there is shown a partial front view of the preferred embodiment of the data storage protection device 10, illustrating exterior casing 51 with removable hard drive access door 82 open and showing removable hard disk drive 86 in place.

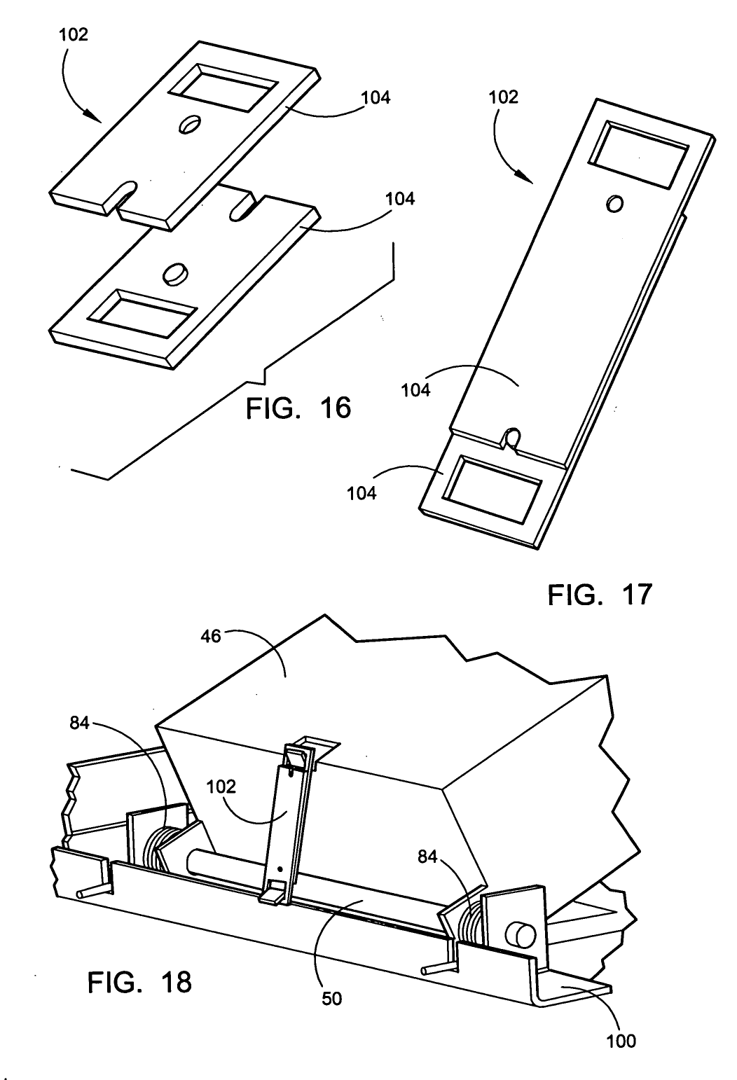

As illustrated in FIG. 16, there is shown an exploded view of thermal fuse 102, showing metal parts 104.

As illustrated in FIG. 17, there is shown a perspective view of thermal fuse 102 outside data storage protection device 10, with metal parts 104 soldered together with low temperature solder that melts at 70 degrees Celsius.

As illustrated in FIG. 18, there is shown a perspective view of thermal fuse 102 attached to hinge assembly 100 and ceramic cover 46, illustrating an alternative embodiment for keeping ceramic cover 46 in the open position. Thermal fuse 102 prevents the tension created by springs 84 attached to spring assembly 50 from closing ceramic cover 46.

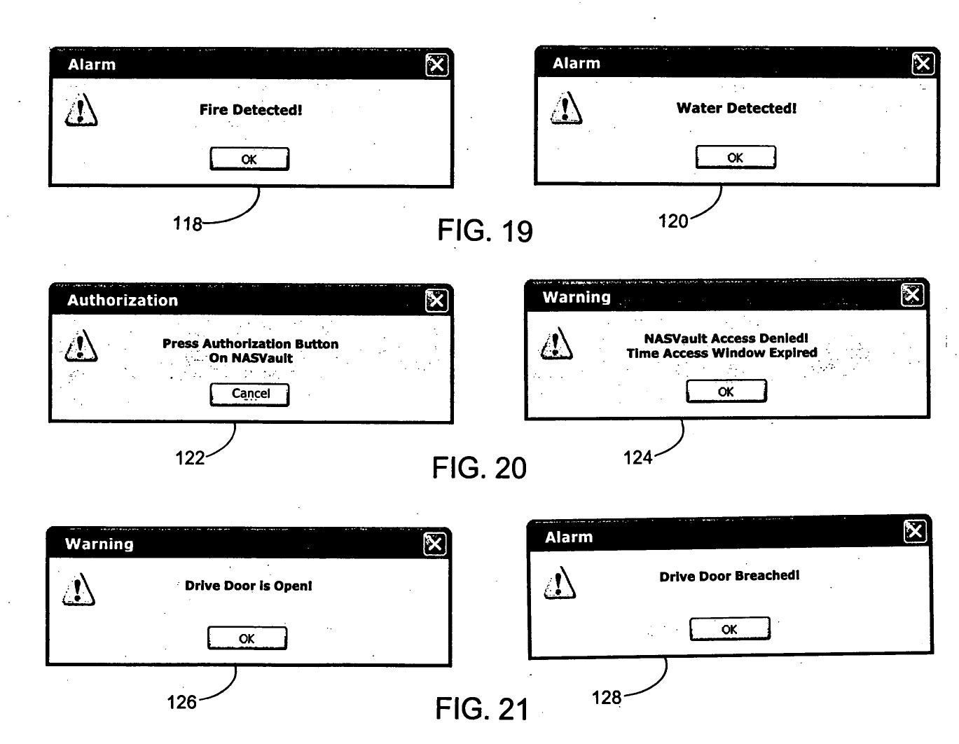

As illustrated in FIG. 19, there is shown a fire detected message 118 and a water detected message 120 that appear on the controlling computer when either fire or water is detected.

As illustrated in FIG. 20, there is shown an authorization notification message 122 that appears when security features have been activated and a user attempts to delete a file or folder, and an access denied message 124 that appears when security features have been activated and a user attempts access files or folders outside the predetermined time frame.

As illustrated in FIG. 21, there is shown a drive door open message 126 that appears at the controlling computer when hard drive access door 82 is open. The user must physically close hard drive access door 82 before drive door open message 126 will disappear. Also, there is shown breach drive door breached message 128 that appears at the controlling computer when hard drive access door 82 is breached.

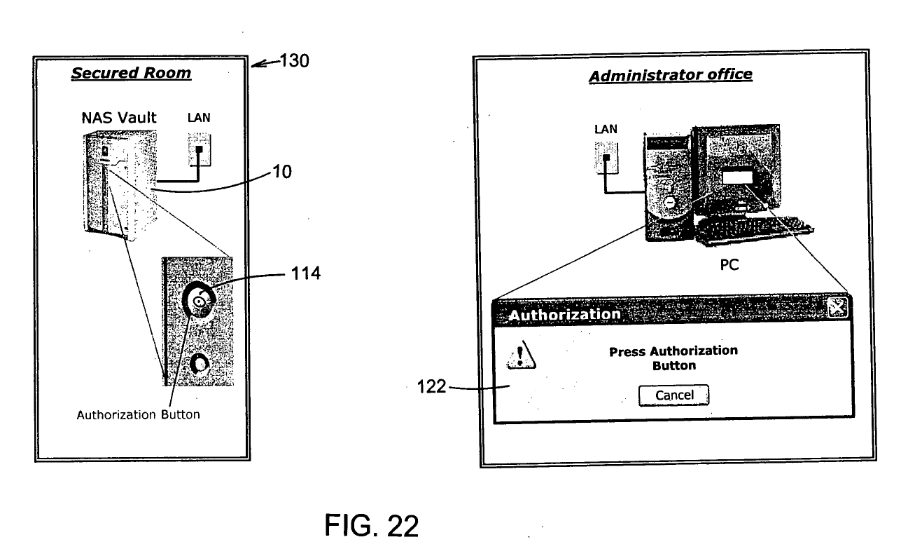

As illustrated in FIG. 22, there is shown the concept of authorization button 114 that is physically located on the front of data storage protection device 10. In a data sensitive installation, data storage protection device 10 can be located in a locked and secured room 130 with only authorized personnel access. To provide double security or tighter security for installations where a locked room is not available, data storage protection device 10 allows the authorized user to set security parameters. To provide flexibility for the user, a graphical user interface (see FIG. 23) will provide authorization button check boxes 131. This feature will protect against file deletion, access to the web user interface, and ejection of removable hard disk drive 86. Once the security features have been activated and the user attempts to delete a file or folder, authorization notification message 122 appears prompting the user to physically press authorization button 114. This procedure provides two layers of security—password knowledge and authorized access to the data storage protection device 10. Authorization notification message 122 will stay displayed until authorization button 114 is pressed or the operation is cancelled. If authorization button 114 is not pressed and the user cancels the request, access to data storage protection device 10 will be denied.

As illustrated in FIG. 23, there is shown the graphical user interface 132 of the controlling computer that is used by the administrative personnel to monitor data storage protection device 10. Graphical user interface 132 contains a hard disk drive eject button 134 which enables additional security features against theft of electronic data by enabling authorized personnel to have control over who can remove or eject removable hard disk drive 86 and when it can be ejected. An additional benefit to this feature is the capacity to offer remote location site access for use in multiple office locations. Once hard disk drive eject button 134 is pressed, hard drive access door 82 will pop open and authorization notification message 122 will appear (see FIGS. 20, 22) at the controlling computer.

When data storage protection device 10 is in use, interface electronics and software provide an interface between sealed hard disk drive 12 and removable hard disk drive 86 and the host computer system. The preferred embodiment of the present invention uses an Ethernet interface to connect to the host computer via LAN or WLAN, and a SATA (Serial ATA) interface to connect to sealed hard disk drive 12 and to removable hard disk drive 86. However, other choices may be made for both the host computer and sealed hard disk drive 12. For example, USB-1.1/USB-2.0 or IEEE-1394 connections can provide a similar interface to the host computer.

Similarly, SCSI, or other connection schemes can be used between the interface electronics and sealed hard disk drive 12. Selection of the interfaces may be tailored to the requirements of each particular need, but in general, will: i) appear to the host computer or network as a normal, on-line, external disk data storage device system, and ii) pass data and commands through the disaster-resistant enclosure with a minimum of compromise to the enclosure function.

A power off button 136 allows the system administrator to disconnect data storage protection device 10 and therefore disable all access to the unit. When data storage protection device 10 is disconnected it will spin down both sealed hard disk drive 12 and removable hard disk drive 86 and enter standby mode. To enable access to data storage protection device 10, the system administrator will have to re-enter a user name and password. A time access window 138 adds additional security access to data storage protection device 10 by allowing access to the unit only during a pre-set time window. For example, the administrator or other authorized user can set the time access window from 8:00 AM through 6:30 PM excluding the weekend. Users therefore can only access their files during that set time period. After shutdown time (i.e. 6:30 PM) access to the data storage protection device 10 will be denied and access denied message 124 (see FIG. 20) will be displayed at the controlling computer.

A temperature display 140 illustrates the temperature of both sealed hard disk drive 12 (internal) and removable hard disk drive 86 (removable). The temperature can be displayed in either Celsius or Fahrenheit.

With respect to the above description it is to be realized that the optimum dimensional relationships for the parts of the invention, including variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described. Accordingly, all suitable modifications and equivalents fall within the scope of the present invention.

The above description, together with the objects of the invention and the various features of novelty which characterize the invention, are pointed out with particularity in the claims annexed to and forming a part of this disclosure. For a better understanding of the invention, its operating advantages and the specific advantages attained by its uses, reference should be made to the accompanying drawings and descriptive matter in which there are illustrated preferred embodiments of the invention.

Further, the purpose of the foregoing abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting, as to the scope of the invention in any way.

We claim

1. A device for storing and protecting electronic data comprising:
a) at least a first means for storing electronic data;
b) at least a first enclosure substantially enclosing said at least a first means for storing electronic data, said at least a first enclosure comprising at least one layer of phase changing and heat absorbing material for the purpose of protecting said at least a first means for storing electronic data from being damaged by excessive heat;
c) at least one interface circuit connected to said at least a first means for storing electronic data, whereby said at least a first means for storing electronic data can interact with a host unit and data can be transferred between said at least a first means for storing electronic data and the host unit; and
d) means for cooling said at least a first means for storing electronic data positioned adjacent to said at least a first means for storing electronic data for the purpose of maintaining normal operating temperature for said at least a first means for storing electronic data
whereby during fire or other potential damaging conditions data transferred to said at least a first means for storing electronic data via said at least one interface circuit is protected from excessive heat damage by said at least a first enclosure and said means for cooling said at least a first means for storing electronic data.

2. The device for storing and protecting electronic data of claim 1, wherein said at least a first means for storing electronic data is a hard disk drive.

3. The device for storing and protecting electronic data of claim 1, wherein said means for cooling said at least a first means for storing electronic data comprises:
a) at least one heat sink;
b) a vent assembly covering said at least one heat sink, said vent assembly containing at least two chambers for the purpose of containing air; and
c) a fan positioned within said vent assembly for the purpose of drawing air within said vent assembly and over said at least one heat sink.

4. The device for storing and protecting electronic data of claim 3 further comprising a means for allowing and preventing air from entering and exiting said vent assembly coupled to said vent assembly.

5. The device for storing and protecting electronic data of claim 3, wherein said means for allowing and preventing air from entering and exiting said vent assembly is a rotatable covering.

6. The device for storing and protecting electronic data of claim 1 further comprising at least a second enclosure substantially enclosing said at least a first enclosure and said means for cooling said at least a first means for storing electronic data, said at least a second enclosure being constructed of a heat absorbing material.

7. The device for storing and protecting electronic data of claim 6 further comprising a means for completely enclosing said at least a first enclosure and said means for cooling said at least a first means for storing electronic data, coupled to said second enclosure.

8. The device for storing and protecting electronic data of claim 7, wherein said means for completely enclosing said at least a first enclosure and said means for cooling said at least a first means for storing electronic data is a spring-loaded covering.

9. The device for storing and protecting electronic data of claim 7, wherein said means for completely enclosing said at least a first enclosure and said means for cooling said at least a first means for storing electronic data is coupled to said second enclosure by a hinged mechanism.

10. The device for storing and protecting electronic data of claim 7, wherein said means for completely enclosing said at least a first enclosure and said means for cooling said at least a first means for storing electronic data is prevented from completely enclosing said means for completely enclosing said at least a first enclosure and said means for cooling said at least a first means for storing electronic data by a fusible alloy clip.

11. The device for storing and protecting electronic data of claim 7, wherein said means for completely enclosing said at least a first enclosure and said means for cooling said at least a first means for storing electronic data is prevented from completely enclosing said means for completely enclosing said at least a first enclosure and said means for cooling said at least a first means for storing electronic data by a thermal fuse.

12. The device for storing and protecting electronic data of claim 11, wherein said thermal fuse is comprised of at least two parts joined by a heat absorbing material having a low melting point.

13. The device for storing and protecting electronic data of claim 1, wherein said at least one interface circuit is electronically connected to said at least a first means for storing electronic data.

14. The device for storing and protecting electronic data of claim 1 further comprising a second means for storing electronic data connected to said at least a first means for storing electronic data for the purpose of serving as a backup storage unit to said at least a first means for storing electronic data.

15. The device for storing and protecting electronic data of claim 14, wherein said second means for storing electronic data is electronically connected to said at least a first means for storing electronic data.

16. The device for storing and protecting electronic data of claim 14, wherein said second means for storing electronic data can be removed from the device for storing and protecting electronic data without shutting down the device for storing and protecting electronic data.

17. The device for storing and protecting electronic data of claim 1 further comprising at least one sensor connected to said at least one interface circuit for the purpose of detecting one or more potential damaging conditions to the device for storing and protecting electronic data, including fire and flood.

18. The device for storing and protecting electronic data of claim 17, wherein said at least one interface circuit contains software for both transmitting information to the host unit upon detection of one or more potential damaging conditions by said at least one sensor and causing one or more notification messages to be displayed to a user of the host unit.

19. The device for storing and protecting electronic data of claim 17 further comprising software for displaying a graphical user interface on the host computer for the purpose of allowing a user of the host unit to monitor and control the operation of the device for storing and protecting electronic data.

20. The device for storing and protecting electronic data of claim 19 wherein said software for displaying a graphical user interface on the host computer provides options displayed on the graphical user interface for a user of the host computer to control who can access the device for storing and protecting electronic data and when it can be accessed.

21. A device for storing and protecting electronic data comprising:
a) at least a first means for storing electronic data;
b) a first enclosure substantially enclosing said at least one means for storing electronic data, said first enclosure comprising at least one layer of phase changing and heat absorbing material for the purpose of protecting said at least one means for storing electronic data from being damaged by excessive heat;
c) at least one interface circuit connected to said at least a first means for storing electronic data, whereby said at least a first means for storing electronic data can interact with a host unit and data can be transferred between said at least one means for storing electronic data and the host unit;
d) a cooling system adjacent to said at least a first means for storing electronic data and substantially contained within said first enclosure for the purpose of maintaining normal operating temperature for said at least a first means for storing electronic data, said cooling system comprising a vent assembly with at least two chambers and at least one fan positioned within said vent assembly; and
e) a second enclosure substantially surrounding said first enclosure and said cooling system, said second enclosure being constructed of a heat absorbing material
whereby during fire or other potential damaging conditions data transferred to said at least a first means for storing electronic data via said at least one interface circuit is protected from excessive heat damage by said first enclosure, said means for cooling said at least a first means for storing electronic data, and said second enclosure.

22. The device for storing and protecting electronic data of claim 21 further comprising a second means for storing electronic data connected to said at least a first means for storing electronic data for the purpose of serving as a backup storage unit to said at least a first means for storing electronic data.

23. The device for storing and protecting electronic data of claim 22, wherein said second means for storing electronic data is electronically connected to said at least a first means for storing electronic data.

24. The device for storing and protecting electronic data of claim 22, wherein said second means for storing electronic data can be removed from the device for storing and protecting electronic data without shutting down the device for storing and protecting electronic data.

25. The device for storing and protecting electronic data of claim 21 further comprising a means for completely enclosing said first enclosure and said cooling system, coupled to said second enclosure.

26. The device for storing and protecting electronic data of claim 25, wherein said means for completely enclosing said first enclosure and said cooling system is a spring-loaded covering.

27. The device for storing and protecting electronic data of claim 25, wherein said means for completely enclosing said first enclosure and said cooling system is coupled to said second enclosure by a hinged mechanism.

28. The device for storing and protecting electronic data of claim 25, wherein said means for completely enclosing said first enclosure and said cooling system is prevented from completely enclosing said first enclosure and said cooling system by a fusible alloy clip.

29. The device for storing and protecting electronic data of claim 25, wherein said means for completely enclosing said first enclosure and said cooling system is prevented from completely enclosing said first enclosure and said cooling system by a thermal fuse.

30. The device for storing and protecting electronic data of claim 29, wherein said thermal fuse is comprised of at least two parts joined by a heat absorbing material having a low melting point.

31. The device for storing and protecting electronic data of claim 21, wherein said at least a first means for storing electronic data is a hard disk drive.

32. A device for storing and protecting electronic data comprising:
a) at least a first means for storing electronic data;
b) at least a first enclosure substantially enclosing said at least one means for storing electronic data, said at least a first enclosure comprising at least one layer of phase changing and heat absorbing material for the purpose of protecting said at least one means for storing electronic data from being damaged by excessive heat;
c) at least one interface circuit connected to said at least a first means for storing electronic data, whereby said at least a first means for storing electronic data can interact with a host unit and data can be transferred between said at least one means for storing electronic data and the host unit; and
d) at least one sensor connected to said at least one interface circuit for the purpose of detecting one or more potential damaging conditions to the device for storing and protecting electronic data, including fire and flood
whereby during fire or other potential damaging conditions data transferred to said at least a first means for storing electronic data via said at least one interface circuit is protected from excessive heat damage by said at least a first enclosure, and upon detection of fire potential damaging conditions by said at least one sensor, said at least one interface circuit can interact with the host unit to notify a user of the fire or other potential damaging condition.

33. The device for storing and protecting electronic data of claim 32, wherein said at least one interface circuit contains software for both transmitting information to the host unit upon detection of one or more potential damaging conditions by said at least one sensor and causing one or more notification messages to be displayed to a user of the host unit.

34. The device for storing and protecting electronic data of claim 32 further comprising software for displaying a graphical user interface on the host computer for the purpose of allowing a user of the host unit to monitor and control the operation of the device for storing and protecting electronic data.

35. A method for protecting data stored on an electronic data storage device comprising the steps of:
a) providing at least a first means for storing electronic data, said first means for storing electronic data including at least a first enclosure substantially enclosing said at least one means for storing electronic data, said at least a first enclosure comprising at least one layer of phase changing and heat absorbing material for the purpose of protecting said at least one means for storing electronic data from being damaged by excessive heat;
b) providing at least one interface circuit connected to said at least a first means for storing electronic data, said at least on interface circuit containing software for both transmitting information to the host unit upon detection of one or more potential damaging conditions by said at least one sensor and causing one or more notification messages to be displayed to a user of the host unit;
c) providing at least one sensor connected to said at least one interface circuit for the purpose of detecting one or more potential damaging conditions to the device for storing and protecting electronic data, including fire and flood; and
d) transmitting information to the host unit upon detection of one or more potential damaging conditions by said at least one sensor and causing one or more notification messages to be displayed to a user of the host unit.

36. The method for protecting data stored on an electronic data storage device of claim 35 further comprising the step of shutting down the electronic data storage device upon detection of one or more potential damaging conditions by said at least one sensor and no response by a user of the host unit.
